(19) United States
(12) Patent Application Publication
(10) Pub. No.: US 2004/0078295 A1
(43) Pub. Date: Apr. 22, 2004

(54) Method for purchases through a network

(76) Inventors: Kuang-Shin Lin, Taipei (TW); Win-Harn Liu, Taipei (TW); Jun Liu, Tianjin (CN)

Correspondence Address: BIRCH, STEWART, KOLASCH & BIRCH, LLP, P.O. Box 747, Falls Church, VA, 22040-0747, US

(21) Appl. No.: 09/750,043

(22) Filed: Dec. 29, 2000

(51) Int. Cl. G06F 17/60

(52) U.S. Cl. 705/27

(57) ABSTRACT

This disclosure described a method for purchases through a network. A consumer can directly purchase products at the manufacturer's web site through a browser and the Internet. The database of the web site will relate the product to relevant free gifts so that the consumer can directly select the free gift he wants through the network. In such a way, the consumer can actually obtain the gift he wants and the manufacturer can lower the cost of the gifts (especially true for installation software).

### BACKGROUND OF THE INVENTION

1. Field of Invention

The present invention relates to a method for purchases through a network and, in particular, to a method for a consumer to select the free gift he wants through the Internet.

2. Related Art

In this information era, computers are more and more popular. In particular, Taiwan information market is not only prosperous but also very competitive. In general, when selling computer products the manufacturer usually give out some software programs or hardware devices as free gifts along with the purchased computer system to attract or reward to customers. For example, most computer manufacturers install certain common software, such as the operating system, word processor, briefing software, spreadsheets software, graph editor, network software and anti-virus software in the computer system purchased by the customer. Moreover, some manufacturers even give out modems or printers for purchases of computer systems.

As an example, customers want software of different kinds; some may want more graph editing or animation processing utilities yet others may need editors for different languages. Therefore, computer manufacturers often install more and more software in order to meet the needs of the market and the customers. This will indefinitely increase the cost in software installation for the manufacturers. Most of the time, the customer only needs a small portion of the installed software in the computer. Even if the hard drive space in current computer systems is bigger and bigger and the memory equipped is more and more, the sizes of all sorts of utilities also grow in multiples. Installing too many utilities will waste the hard drive space. Especially when too many resident programs exist in memory at the same time will occupy too many hardware resources and seriously influence the efficiency of the computer system.

### SUMMARY OF THE INVENTION

In observation of the foregoing, it is then an object of the invention to allow a user to purchase the computer product he really wants through the Internet and in the same manner select the free gifts he needs online.

Pursuant to the above object, the present invention provides a method for purchasing through a network. First, the manufacturer shows relevant pictures and descriptions of the contents and functions of its products on a web page. The customer can directly select the products he wants using a browser connecting to the Internet and send out a product purchase message to the web site. The web site then provides a list of related free gifts according to the above message for the customer to select the combination and contents of the free gifts. The customer is not only able to obtain the gifts he really wants but the manufacturer can also lower the cost in gifts (especially in software installation).

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 depicts a schematic view of a data processing procedure according to the present invention;

FIG. 2 depicts a flow chart of a data processing procedure at a client according to the invention;

FIG. 3 depicts a flow chart of a processing procedure at a manufacturer;

FIG. 4 depicts a schematic view of a wholesale structure according to the invention;

FIG. 5 is a schematic view of a first web page of the invention in practice;

FIG. 6 is a schematic view of a second web page of the invention in practice; and

FIG. 7 is a schematic view of a third web page of the invention in practice.

### DETAILED DESCRIPTION OF THE INVENTION

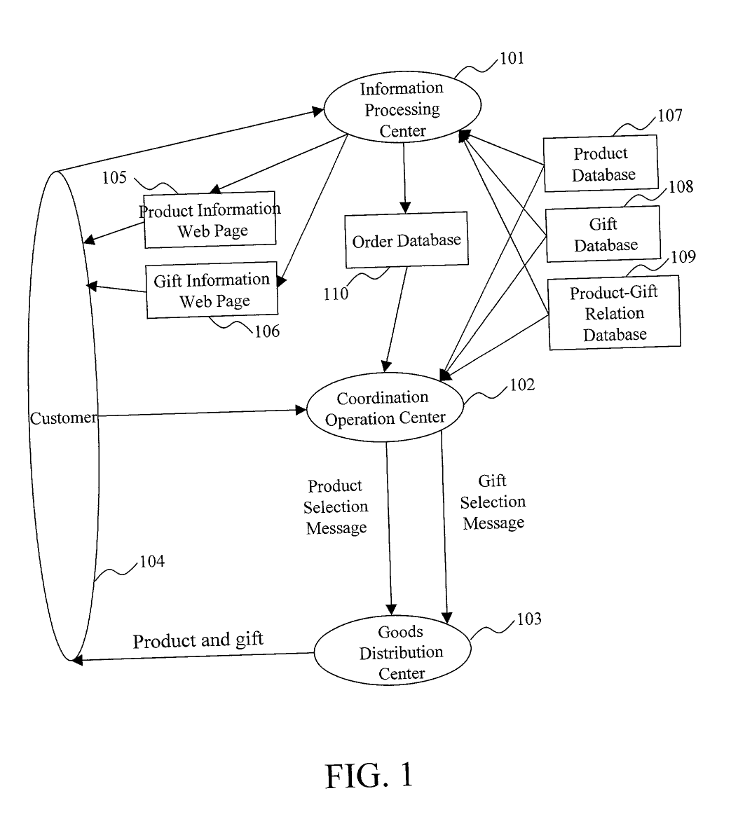

FIG. 1 depicts a schematic view of a data processing procedure according to the present invention. The drawing demonstrates the whole sale and processing procedure of a product and gifts. The manufacturer sets up an information processing center 101 (including a shopping web site) to provide product information web page 105 for a customer 104 to browse online through the Internet. When the customer 104 selects a desired product through the browser, a product purchase message will be sent to the information processing center 101, which then sends out a related gift message web page 106 to the browser accordingly so that the customer 104 can select the gifts he wants directly. The gift selection message is then sent back to the information processing center 101. After confirming by the information processing center 101, the product and gift selection messages are stored together. This then completes the purchase procedure.

The above-mentioned information processing center 101 can be a server established in the Internet by the manufacturer or a bigger computing center that includes the server. However, the information processing center 101 is not only responsible for the communication interface between the manufacturer and the customer 104, but also needs supports from some databases. The most important databases are a product database 107, a gift database 108 and a product-gift relation database 109. The contents and the data structure of the product database 107 are shown in TABLE 1. Aside from storing relevant information of each product, it can be set to append quantities and ranges of gifts for selection.

TABLE 1

| CATEGORY | TYPE | LENGTH |
|---|---|---|
| PRODUCT NAME | Char | 60 |
| PRODUCT SERIAL NUMBER | Int | |
| PRODUCT TYPE | Char | 10 |
| PRODUCT PRICE | Money | |
| INTRODUCTION | Text | |
| QUANTITIES OF GIFTS | Int | |

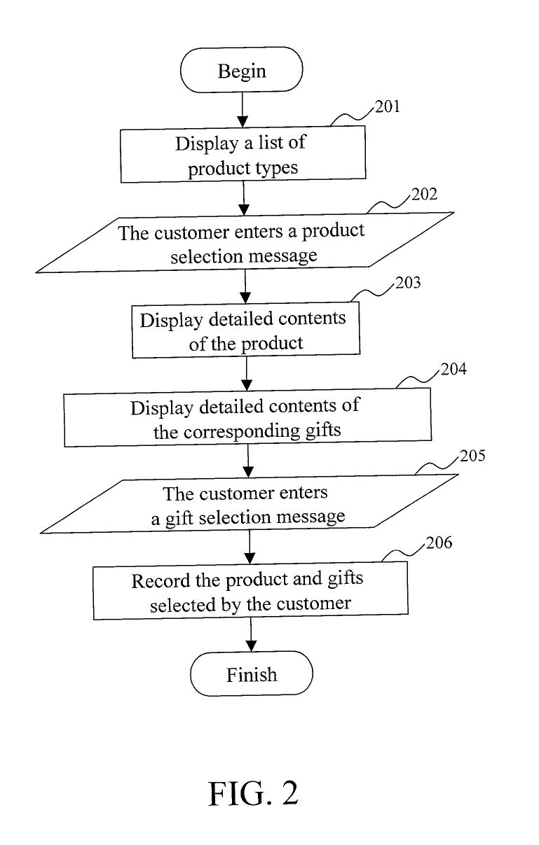

The contents and the data structure of the gift database 108 are shown in FIG. 2. It is used to store all the relevant information about the gifts, serial numbers and introductions.

TABLE 2

| CATEGORY | TYPE | LENGTH |
|---|---|---|
| GIFT NAME | Char | 60 |
| GIFT SERIAL NUMBER | Int | |
| INTRODUCTION | Text | |

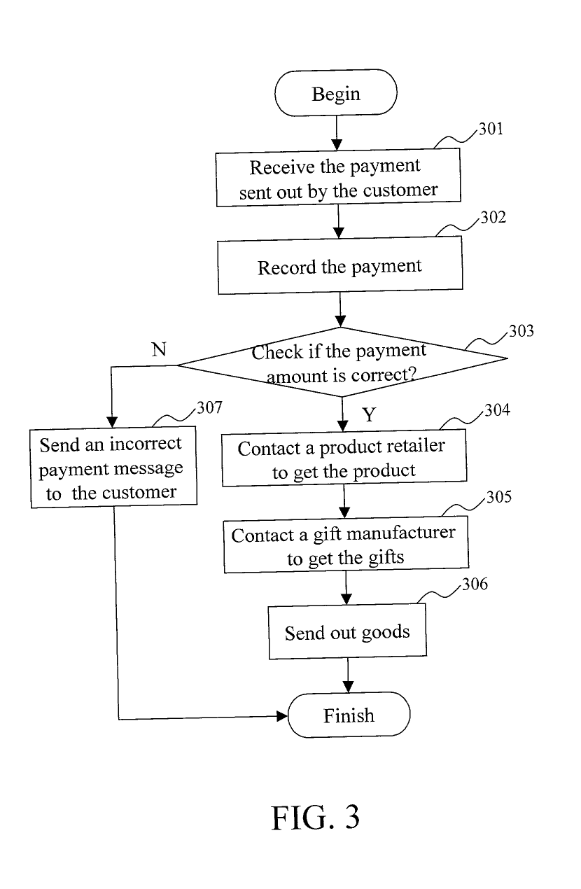

The contents and the data structure of the product-gift relation database 109 are shown in FIG. 3. The function of this database is to form relations among items in the product database 107 and those in the gift database 108.

TABLE 3

| CATEGORY | TYPE | LENGTH |
|---|---|---|
| PRODUCT SERIAL NUMBER | Int | |
| GIFT SERIAL NUMBER | Int | |

Besides the above three databases, the information processing center 101 will store the messages of products and gifted selected by the customer 104 in an order database 110. The procedure then enters a coordinating operation center 102, which obtains detailed data of the products and gifts ordered by the customer 104 according to the contents in the order database 110 and by referring to the product database 107, the gift database 108 and the product-gift relation database. After confirming the receipt of the payment sent out by the customer 104, the coordinating operation center 110 then sends out a product order and a gift order to a goods distribution center 103, which is in charge of sending the products and gifts to the customer 104.

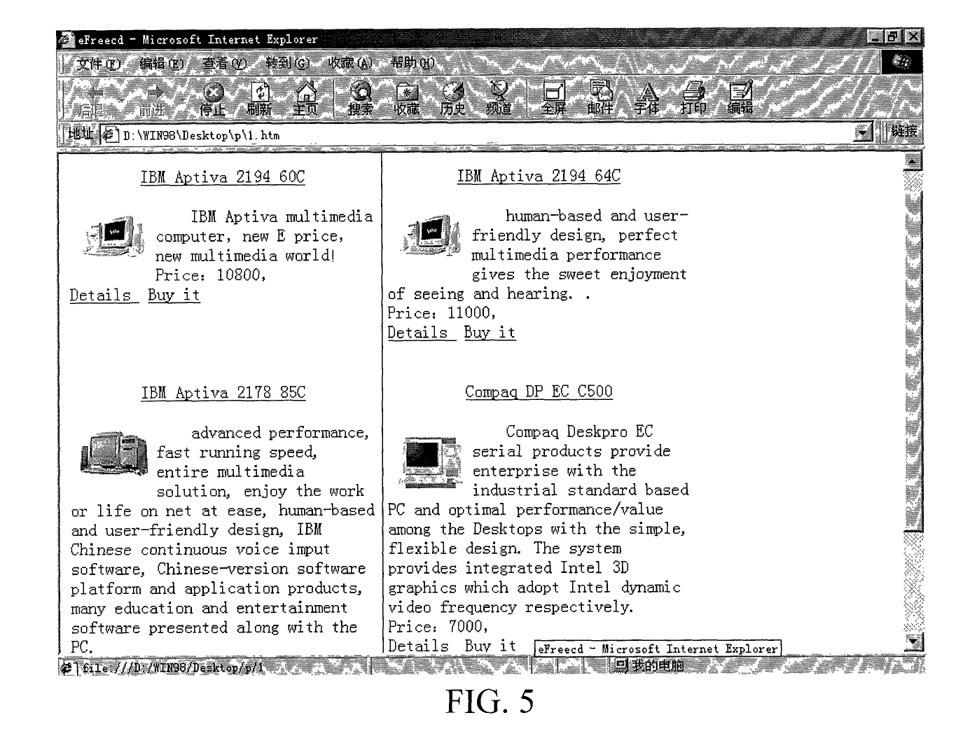

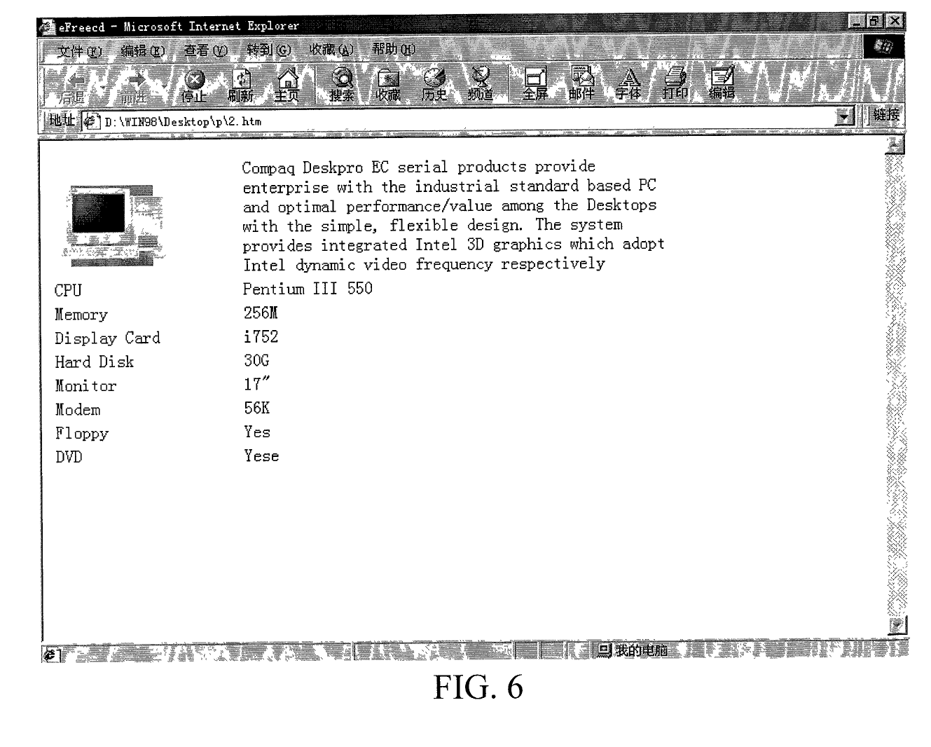

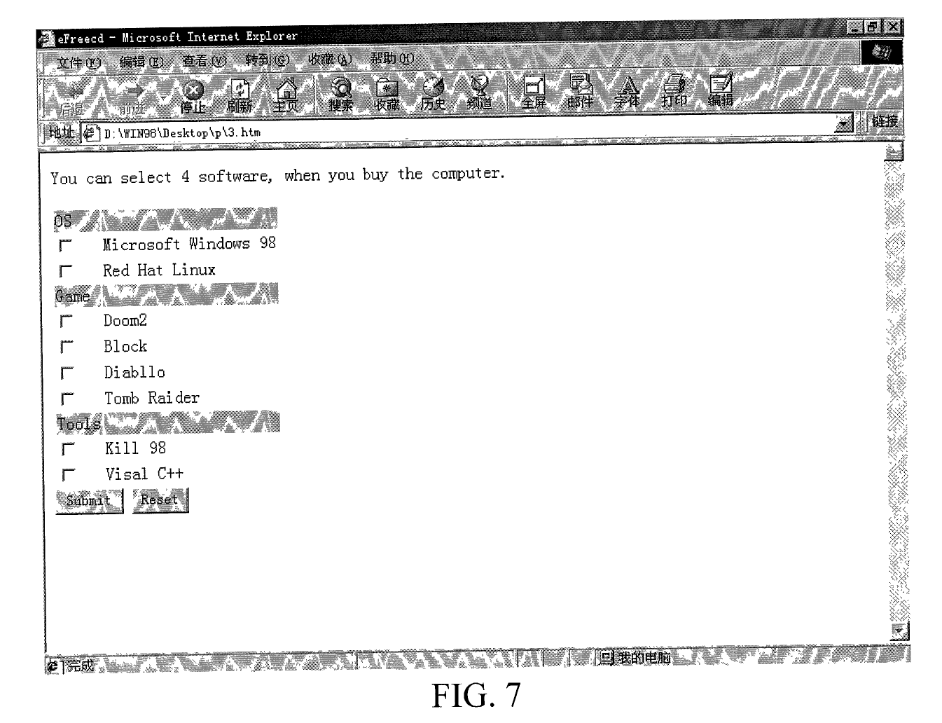

Please refer to FIG. 2, which depicts a flow chart of a data processing procedure at a client according to the invention. When the customer 104 enters a shopping web site constructed on the Internet by the manufacturer through a browser. The web site displays the products for sale on its product web page (step 201), which can be implemented as shown in FIG. 5. The customer 104 can select the products with reference to the introductions of the products shown in the web page. When the customer 104 selects a product he wants and enters a product selection message (step 202), the web site will display further detailed contents and introductions of the product (step 203), as shown in FIG. 6, then display a list of the corresponding gifts and the detailed contents (step 204), as shown in FIG. 7. The customer can select the gift combination and content he needs or prefers (step 205). Finally, the server at the shopping web site stores the product and gifts selected by the customer 104 (step 206). This then completes the shopping procedure on the customer side.

Please refer to FIG. 3 for the processing procedure for the manufacturer. When the manufacturer receives the payment sent out by the customer (step 301), it first stores the amount of the payment and relevant data (step 302) and then refers to the order database 110 to check if the payment amount is correct (step 303). If it is incorrect (such as insufficient payment), then an incorrect payment message is sent to the customer 104 and the procedure finishes. If the payment is correct, then the manufacturer contacts a product retailer to get the product (step 304) and contacts a gift manufacturer to get the gifts (step 305). Finally, the manufacturer sends out the product and gifts (step 306). This then completes the operation procedure on the manufacturer side.

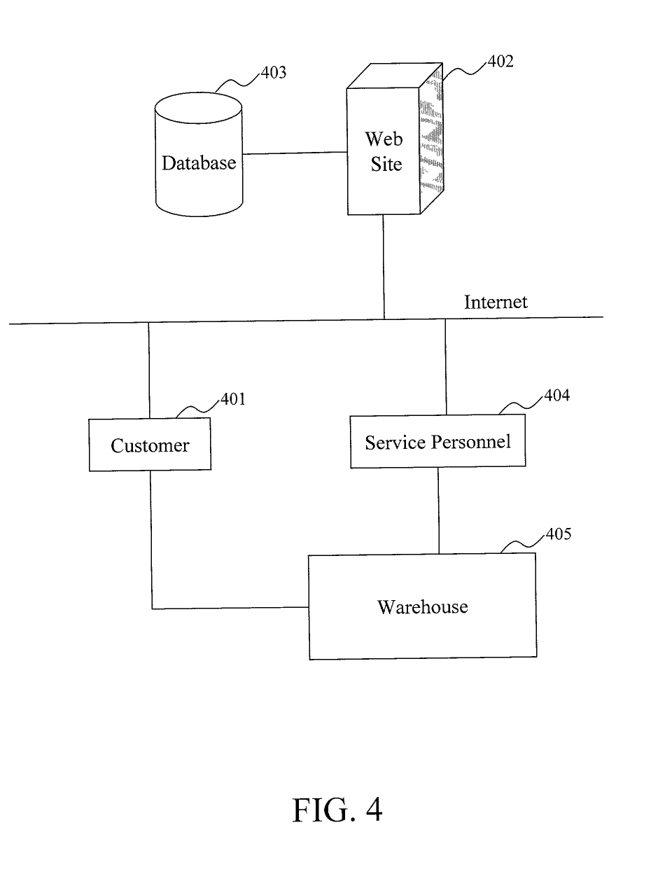

Please refer to FIG. 4, which depicts a schematic view of a wholesale structure according to the invention. The customer 104 browses the shopping web site 402 and orders a product through the Internet. The shopping web site displays relevant information about the product and the gift through the supports of databases, and stores relevant information about the order given by the customer 104. The retailer ten gets the customer order from the recorded maintained at the shopping web site 402, confirms that payment of the order has been received, then sends a carrier to the warehouses of the product and gift manufacturers to get those items that are to be sent to the customer.

From the above description, one can see that the invention allows a customer to select the gift contents he prefers after he selects the product he wants to purchase directly through the Internet by means of a web page that is designed to be able to relate products to the corresponding gifts. For example, the customer can select a couple of utilities from a plurality of authentic application programs. Since the gifts are determined by the customer himself, they will be more useful to the customer. On the other hand, the manufacturer can provide more software for selection to attract more customers without increasing the cost for installing software that the customer does not like.

### EFFECTS OF THE INVENTION

The instant invention allows a customer to select the gift contents he prefers after he selects the product he wants to purchase directly through the Internet by means of a web page that is designed to be able to relate products to the corresponding gifts. The gifts will be more useful to the customer. Moreover, the manufacturer can attract more customers by providing more software for selection without increasing the cost for installing software that the customer does not like.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for purchasing a product through a network so that a customer can select and order a product at a web site using a browser and determine the gifts the customer wants through the Internet, which method comprises the steps of:
sending out a product selection message through the browser from the customer to the web site;
the web site providing a list of related gifts on the browser according to the product selection message;
the customer selecting the gift contents from the list of gifts and sending a gift selection message to the web site through the browser; and
the web site storing both the product selection message and the gift selection message.

2. The method of claim 1 further comprising the step of displaying a list of the product types on the browser for the customer's reference.

3. The method of claim 2, wherein the list of the product types is displayed in the form of a web page.

4. The method of claim 3, wherein the detailed contents of both the selected product and the corresponding gifts are displayed in the form of a web page.

5. The method of claim 1 further comprising the step of displaying the detailed contents of the selected product and the detailed contents of the corresponding gifts for the customer's reference.
